(19) United States
(12) Patent Application Publication
(10) Pub. No.: US 2011/0188044 A1
(43) Pub. Date: Aug. 4, 2011

(54) REAL-TIME WIDE-RANGE REFLECTIVE AUTOCORRELATOR

(76) Inventors: Guilin Mao, Beachwood, OH (US); Yeheng Wu, Cleveland, OH (US)

(21) Appl. No.: 12/697,277

(22) Filed: Jan. 31, 2010

(51) Int. Cl. G01B 9/02

(52) U.S. Cl. 356/450

(57) ABSTRACT

In this invention, multiple pairs of reflective mirror on a high-precision stable rotation stage generate a repetitive wide range delay in a noncolinear intensity autocorrelator. Such autocorrelator is real-time, background-free, dispersion free. It has a continuous long scanning range, from a few femtoseconds to hundreds of picoseconds.

### CROSS-REFERENCE TO RELATED APPLICATIONS

Not Applicable

### FEDERALLY SPONSORED RESEARCH

Not Applicable

### SEQUENCE LISTING PROGRAM

Not Applicable

### BACKGROUND OF THE INVENTION

1. Field

This invention concerns an optical autocorrelator, a device of measuring the pulse width of the short laser pulses.

2. Background

Autocorrelator has been widely used to measure the pulse width of ultrafast laser pulses. An autocorrelation splits a laser beam into two, delays one of them in time, and recombines them for time-correlation characterization. The common autocorrelator varies the delay by linearly translating the reflection mirror of one of the split beams (see U.S. Pat. No. 6,195,167, U.S. Pat. No. 5,033,853, U.S. Pat. No. 4,973,160). Another well-known way of delaying the laser beams includes inserting one or multiple wedged optical glass (n>1) (See U.S. Pat. No. 4,190,366, U.S. Pat. No. 6,195,167, U.S. Pat. No. 4,265,540). Another way of doing the delay is rotating one or multiple optical glass block (see U.S. Pat. No. 4,872,756, U.S. Pat. No. 4,406,542). However, all of these methods have disadvantages: (1) for the linear translation method, realization of the repeatable back-and-forth linear moving is difficult and the mechanics backlash is always a problem. And the measurement range of pulse width is limited and currently this type of commercial autocorrelator is only applicable for femtosecond laser pulse; (2) For those delaying methods by inserting wedged or non-wedged optical block, additional dispersion is introduced. In other words, the autocorrelator itself will broaden the laser pulse while measuring the laser pulse width. This disadvantage becomes extremely obvious while measuring ultrafast laser pulse, for example, a few or a few tens of femtoseoconds laser pulse.

In this invention we delay the laser pulse by rotating multiple reflective mirrors on the stability-enhanced rotation stage. This is an improvement of the prior art described in a published paper (Opt. Commun. 36(5), 1980). The method used in this paper has two disadvantages: (1) the repeatability and smoothness of the rotation is not very good which results in the jittering of the autocorrelation pulse; (2) rotating only one pair of mirror can only measure laser pulse with high repetition rate (usually >1 Mhz because only in small angle the rotation angle is linear to the generated time delay of the laser pulse). In this invention, a high-precision brushless motor and rotator with position feedback is used to ensure the best stability and smoothness of the rotation. One, two or four pairs of rotating mirrors are used to ensure that the autocorrelator can measure laser pulse with wide repetition rate range, from few hundred Hz to MHz and to GHz. Minimized dispersion makes the autocorrelator suitable for all types of short pulses, from a few femtoseconds to more than 100 picoseconds.

### BRIEF DESCRIPTION OF DRAWINGS

FIG. 1 is a schematic layout of the optical components of the autocorrelator (TOP-VIEW).

FIG. 2 illustrates the positions of the optical components when the disc rotates 45 degrees.

FIG. 3 is a schematic drawing of the rotating delay line with 8 mirrors (4 sets).

FIG. 4 is a auto-correlation trace of a mode-locked Ti:sapphire laser given by the embodiment depicted in FIG. 1.

### DRAWINGS—REFERENCE NUMBERS

1,2, 5,6, 7,8,9,10 parallel rotation mirror pair

3 flat mirror

4 high-precision rotation stage

11 beam splitter

13 roof mirror

14 curve mirror

15 nonlinear second harmonic generation crystal

16 PMT photo multiplier tube

17 Frequency counter

### DETAILED DESCRIPTION—FIRST EMBODIMENT—FIGS.

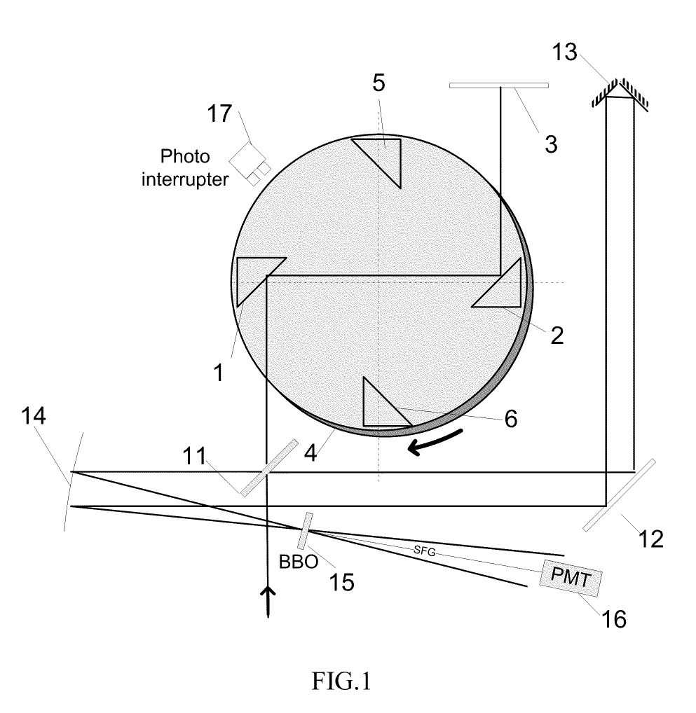

The pulse duration of a short laser pulse can be revealed via intensity autocorrelation between two child pulses created by a beam splitter. The two child pulses are focused on the same spot on a nonlinear crystal in order to generate sum-frequency signal (SFG), which has a temporal profile which reflects the temporal profiles of the original laser pulse. The essential parts used in this invention are the parallel reflective mirror sets. The first embodiment is depicted in FIG. 1. As shown in the figure, two parallel mirrors (1 and 2, or 4 and 5) work as a variable optical delay component when they rotate. Laser light hits mirror 1 at approximately 45° incident angle and then hits mirror 2. The outgoing beam from 2 hits on mirror 3 at normal angle. Thus the beam is reflected back and hits the beam splitter again. The reflected beam from the beam splitter forms the first child beam. The repetitive delay is generated by rotation stage. Let's assume rotation stage rotates by θ, then the optical delay changes is 2d(cosθ+sinθ−1), where d is the distance from 1 to 2. With small angle approximation, the delay is 2dθ, which is linearly proportion to the angle or the time of rotation. After the rotation stage rotates 90°, the same process repeats by the parallel mirrors 4 and 5. After 180°, mirror 1 and 2 repeats. In a full 360° rotation, four autocorrelation events can be observed.

The incoming beam is split into two beams by beam splitter 11. One arm of the beam is directed to the roof mirror 13, which shifts the reflected beam laterally on the horizontal plane. Another arm goes to the rotating delay line. The two arms are brought together parallel using the beam splitter 11 and focused on a BBO crystal 15 by a curved mirror 14. The sum frequency generation is monitored by a photon detector 16—photo multiplier tube (PMT). The signal from the PMT is amplified and then can be visualized on an oscilloscope, a computer or other waveform devices.

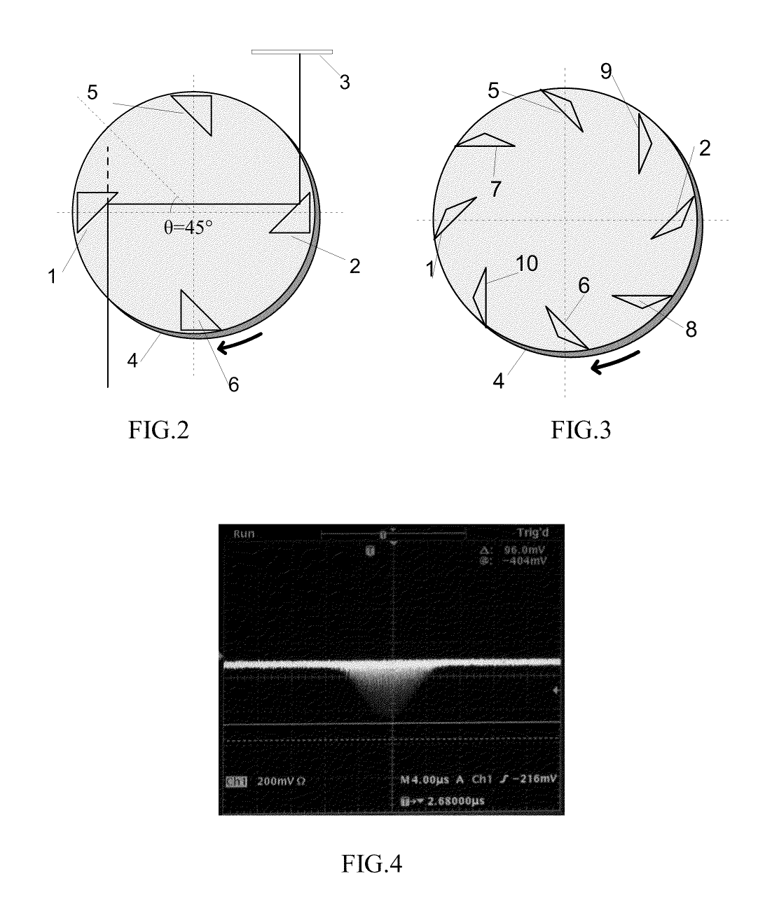

As shown in FIG. 2, when the disc rotates to θ=90°, mirror 6 occupies the initial position of 1. When the disc rotates θ=180°, mirror 2 occupies the initial position of 1. Thus, within one rotation, four autocorrelation events can be achieved. Two unique advantages can be easily seen: (1) due to symmetry of the design, a highly stable rotation stage can be achieved which is extremely important for sensitive ultrafast optics measurement (for example, 1 micrometer corresponds 3.3 femtoseconds which is resolution of the autocorrelator. This means that any mechanical noise larger than 1 micrometer can severely affect the autocorrelation; (2) multiple autocorrelation events can be obtained in every single rotation, which is especially important in measuring low-repetition rate laser pulse. FIG. 3 is another embodiment of our design, in which eight reflective mirrors are used to further improve stability and efficiency of the measurement.

FIG. 4 shows the autocorrelation curve of a mode-locked Ti:Saphire laser using the embodiment depicted in FIG. 1. The high-precision rotation stage rotated at a speed of 468 RPM. The distance between the two parallel mirrors is 7.5 cm. The FWHM of the trace on the oscilloscope is about 7 μs, which give a measurement of the laser pulse of 119 fs.

We claim:

1. a real time wide range reflective autocorrelator comprising:
(a) 2 sets of reflective parallel mirrors, which create the continuous time delay through rotation
(b) a high-precision stable rotation stage
(c) a roof mirror which can be mounted on a linear translation stage and change the linear delay of this arm
(d) a curved mirror which focuses two child pulses on the same spot of the nonlinear crystal
(e) a nonlinear crystal that converts the delay between two child pulses into SHG signal
(f) a photon detector that can detect the sum-frequency signal
(g) a beam splitter that splits the beam into two beams
(h) a frequency counter that determines the rotating speed of the stage

2. the autocorrelator in claim 1 wherein 3, 4 or more sets of reflective parallel mirrors are used.

3. an autocorrerlator in claim 1 where the photon detector means a photo multiplier tube, an avalanche photodiode, a Si photo diode or a InGaAs photo diode.

4. an autocorrelator in claim 1, wherein the rotation stage 4 is driven by brushless motor and rotates clockwise or counterclockwise

5. an autocorrelator in claim 1, which measures laser pulse width from a few femtoseconds to hundreds of picoseconds

6. an autocorrelator in claim 1, wherein the nonlincear crystal can be BBO, LBO, KDP, KTP and any other second harmonic generation crystals
